(19) United States
(12) Patent Application Publication
(10) Pub. No.: US 2007/0148289 A1
(43) Pub. Date: Jun. 28, 2007

(54) Food bar

(75) Inventors: Akhilesh Gautam, Plano, TX (US); Matthew Patrick, Annapolis, MD (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a Unilever

(21) Appl. No.: 11/320,008

(22) Filed: Dec. 28, 2005

(51) Int. Cl. A23L 1/30

(52) U.S. Cl. 426/72

(57) ABSTRACT

Food bars, especially low carbohydrate layered food bars, having good organoleptic properties prepared using mesomorphic phase of edible surfactant in the crème or filling layer. Preferably, the mesophase is present in the filling layer in bulk. By use of mesophase surfactants, it is possible to minimize or eliminate sugar alcohols from common crème layers such as caramel and marshmallow and still produce a bar of similar or larger size with lower or comparable caloric impact to the sugar alcohol-containing bars. Preferably, the mesophase has a water activity of less than 0.7 and a water content of less than 80%, especially 75% or less. Preferably, the mesophase includes at least 5 wt % surfactants, especially at least 15 wt. % surfactants, preferably mono- and di-glycerides. A preferred range for the mono- and diglycerides is from 15 to 20 wt. %. Advantageously, a humectant such as glycerine or a sugar such as sucrose or a sugar alcohol causing less GI disturbance such as erythritol, or another polyol, fiber, a fat replacer such as Z-Trim or salt is included as well.

### BACKGROUND OF THE INVENTION

Losing weight continues to be an important, but difficult, challenge for many individuals. Reports of an increase in average weight have suggested numerous causes, such as overuse of automobiles, video games, computers and television. Diminished interest in smoking and insufficient attention to nutrition by individuals trying to fulfill frenzied schedules, may also play roles. Widespread weight gain is of special concern in view of its reported links to diabetes and heart disease.

Nutrition and other food bars have grown in popularity in recent years. Nutrition bars typically contain a balanced mix of macronutrients and of micronutrients such as vitamins and minerals. Other food bars may be focused on providing sources of quick energy or satisfying other physiological needs. Nutrition bars can be convenient vehicles for replacement of a meal since, unlike many snacks, they contain the mix of valuable nutrients. Nutrition and food bars are both useful as snacks intended to boost energy. And, both as snack and meal replacement bars, nutrition and food bars may be used by those seeking to lose weight.

There have been many weight regulation trends in the past twenty years as individuals and health professionals have sought the best approaches for weight loss. At one point, ingestion of low fat foods seemed the most popular method. In the last few years, more diets have tended to emphasize ingestion of foods having low levels of carbohydrates. Whatever type of diet is embarked upon, the total number of calories is generally considered to be a significant factor in weight gain.

Sugar alcohols have been used in bars to impart sweetness or bulk while reducing the presence of sugars. For instance, low carbohydrate layered bars typically utilize a creme layer such as caramel or marshmallow including sugar alcohols such as maltitol. However, some individuals experience gastrointestinal side effects when ingesting significant amounts of sugar alcohols, so it is desirable in some applications to minimize or avoid their use. Also, some have questioned the accuracy of the sometimes-reported assumption that sugar alcohols do not contribute to weight gain in the same way as carbohydrates.

It goes without saying that, however nutritious or healthful a product is, it must be organoleptically appealing to consumers or it is likely to be relegated to the garbage heap of unsuccessful weight loss offerings. Attaining a desirable organoleptic profile is particularly difficult in a nutrition bar wherein there is a need for enhanced flavor to mask off-tastes associated, for example, with micronutrients such as certain vitamins.

Numerous patent and other documents have disclosed food bars, e.g., Jones U.S. Pat. No. 6,749,886 (confectionery bars having a proteinaceous material and a carbohydrate material in a relative weight ratio higher than 1), McKenzie U.S. Pat. No. 6,143,335 (low moisture food bar or cube for supplementing the diets of both animals and humans-moisture level of less than 5 wt. %), WO 01/56402, Portman U.S. Pat. No. 6,051,236, Gilles et al. U.S. Pat. No. 6,248,375, Anon, “Nutraceuticals-International,” 2000, Vol 5, p25 (from abstract number 548502), Keating et al. EP 768043, WO 03/079818, Sears U.S. Pat. No. 6,140,304 and DeMichele et al. U.S. Pat. No. 6,444,700.

Numerous efforts to replace fat or bulk in foods are known from the patent literature.

Heertje et al. U.S. Pat. Nos. 6,368,652, 6,368,653, and 5,652,011, and Wesdorp et al. U.S. Pat. No. 5,620,734 are directed to use of mesomorphic phases of edible surfactants to provide structuring or fat replacement in finished or ready-to-eat foods.

Gautchier et al. U.S. Pat. No. 5,968,583 is directed to mesomorphic phases of edible surfactants which can be used in preparing sandwich cookie filler creams, for example to provide structuring or fat replacement. The mesomorphic phases may also be used in frostings.

Miller et al. U.S. Pat. No. 6,068,876 discloses mesophase-stabilized emulsions and dispersions used in low-fat and fat-free food products.

Kleinherenbrink et al. WO 95/35035 discloses a process for preparation of a pasteurized or sterile mesomorphic phase of surfactants.

US 2004 0191387 discloses an emulsifier composition for bar cakes. A reference disclosing mesophase emulsifiers in cake batters is discussed in the background section.

EP 020 421 and U.S. Pat. Nos. 4,005,195 and 4,005,196 are directed to sugar polyesters as fat replacers in foods.

Singer et al. U.S. Pat. No. 4,734,287 discloses proteinaceous, water-dispersible macrocolloids comprising substantially non-aggregated particles of dairy whey protein. The macrocolloids are said to provide a mouthfeel like that associated with fat/water emulsions.

Singer et al. U.S. Pat. No. 4,961,953 is directed to proteinaceous, water-dispersible macrocolloids which in a hydrated state have a substantially smooth, emulsion-like organoleptic character. The macrocolloids are said to provide a mouthfeel like that associated with oil-in-water emulsions.

GB 2,363,049 discloses a food product having a filling of high moisture content, a coating of lower moisture content and a barrier layer between them.

Although there are many food bars on the market, it would be desirable to be able to produce one which has good organoleptic properties yet further reduced calories and/or increased size. Even more desirable would be to attain this objective in a nutrition bar, especially a layered nutrition bar, having comparable or reduced levels of sugar alcohols.

### SUMMARY OF THE INVENTION

The present invention is directed to the discovery that food bars, especially low carbohydrate and sugar reduced layered food bars, having good organoleptic properties can be prepared using mesomorphic phase of edible-surfactant in the filling or crème layer. Preferably, the mesophase is present in the crème or filling layer in bulk. By use of mesophase surfactants, it is possible to lower levels of sugar alcohols, or eliminate them, from common crème layers such as caramel and marshmallow and still produce a bar of similar or larger size with lower or comparable caloric impact to the sugar alcohol-containing bars. In particular, by use of the mesophase-containing fillings sugar alcohols can be kept at a level which minimizes GI disturbances even though the overall size of the bar is increased.

In accordance with a further aspect of the invention, it has been discovered that a mesophase having certain characteristics is particularly suitable for use in fillings for food bars, such as in fillings for layered food bars or extruded bars. In particular, the mesophase has a water activity of less than 0.7 and a water content of less than 80 wt. %, especially 75% or less. Preferably, the mesophase includes at least 5 wt % surfactant, especially at least 15 wt. % surfactants, preferably mono- and di-glycerides and at least 5 wt. % water. Preferred water ranges within the filling extend from 20 to 80 wt. %, especially from 30 to 75 wt. %. In some formulations water levels for the filling may range from 25 to 45 wt. %. A preferred range for the mono- and diglycerides is from 5 to 20 wt. %.

Advantageously, one or more additional desirable ingredients for the filling include a humectant such as glycerine, a sugar such as sucrose, a sugar alcohol causing less GI disturbance such as erythritol or another polyol, fiber, a fat replacer such as Z-Trim (available from FiberGel Technologies, Inc. of Mundelein, IL.) and salt. Betaine is another ingredient which may be present, e.g., at from 0 to 25 wt. %, especially from 2 to 15 wt. %.

In a further aspect of the invention, moisture migration from one layer to another is impeded or prevented by use of an edible moisture barrier. Since the mesophase-containing layer is likely to have a higher water activity than other layers, such a barrier will help preserve the integrity of the bar against damage due to moisture migration.

By food bars herein we refer to somewhat elongated foodstuffs which retain their shapes when held at one end at room temperature. We exclude frozen products which lose their shape at room temperature. Preferably, the bars of the invention include at least a base layer, a filling layer adjacent the base layer and an optional coating.

For a more complete understanding of the above and other features and advantages of the invention, reference should be made to the following description of the preferred embodiments.

### DETAILED DESCRIPTION OF THE INVENTION

The formation of mesomorphic phases of edible surfactant molecules and water can give rise to a firm texture and consistency. This way of product structuring may be described e.g. as a regular, molecular arrangement of surfactant molecules with intervening aqueous regions. For the purpose of the invention the term mesomorphic phase is intended to include all semi-ordered phases of water and edible surfactant materials. Examples of mesomorphic phases are cubic, hexagonal, alpha crystalline gel, beta-crystalline coagel and lamellar phases. Preferred mesomorphic phases for use in accordance with the invention are lyotropic phases; also preferred are lamellar phases. For the purpose of the present invention, the term lamellar phase refers to any system having a pattern of alternating bilayers of edible surfactants and water. Examples of lamellar phases are lamellar droplet phases, lamellar gel phases and lamellar phases containing extended parallel layers of surfactants and water.

In the lamellar phase, surfactants are believed to form a bilayer structure. It is believed that a bulk lamellar phase comprises stacks of bi-layer structures with an intervening aqueous phase. Products according to the present invention preferably comprise bulk regions of the lamellar phase whereas the present invention is not directed to encompass mere boundary layers of this phase at interfaces, such as those found around oil-droplets in water-continuous fatty products.

The bulk lamellar phase may be formed by temperature cycling of a mixture of surfactant and water. In the crystalline state, the surfactant molecules are oriented with adjacent hydrophilic groups and the hydrophobic chains are parallel and densely packed. On contact with water and heating to the so-called ‘Krafft’ temperature it is believed that water penetrates between the adjacent ‘head’ groups to form a ‘liquid crystal’ structure. On cooling below the ‘Krafft’ temperature, the hydrophobic chains pack into a regular lattice, producing a one-dimensionally periodic ‘sandwich’ structure of alternating surfactant and aqueous layers.

As an example of the ‘gel’ structure obtained: for a mixture of water and a distilled monoglyceride made from fully hydrogenated lard, which has been cycled above the Krafft temperature, X-ray diffraction in the low-angle region reveals that the thickness of the monoglyceride layers is of the order of 50-60 Angstrom. As the proportion of water in the mixture in the system is increased the inter-planar spacing increases, as water is taken up between the monoglyceride layers. It will be realized that the fine structure of the mesomorphic phase, especially as regards the inter-planar spacing, will vary when different surfactants are used.

Distilled monoglycerides are preferably as pure as possible to afford the best taste.

Another preferred mesomorphic phase according to the invention is a beta-crystalline coagel, which is believed to comprise small plate-like crystals having an average thickness of less than 1 μm or even less than 0.1 μm, said platelets being dispersed in an aqueous environment. This is a suspension of beta-crystalline emulsifier in water and is also known as a “hydrate.” These coagels may be formed instead of an alpha crystalline gel phase under certain conditions, such as at acid pH. Both the above mentioned alpha gels and these hydrates are used extensively in the baking industry as crumb softening agents in wheat bread and as cake volume improvers, but it is believed that the structure of the mesomorphic phase is lost during product preparation and consequently that the finished foodstuff (be it bread or cake) does not contain bulk mesomorphic phase. In the context of the invention the coagel phase is considered a semi-ordered phase of water and edible surfactant (mesomorphic phase).

The presence of mesomorphic phases in food products may be detected by any method suitable for the detection of regular arrangements of surfactant materials. Suitable methods include for example NMR, Electron microscopy, Differential scanning calorimetry, light microscopy and X-ray diffraction.

The mesomorphic phase and method of preparation are known to food scientists. In the “Lipid Handbook” of Gunstone, Harwood and Padley (Chapman and Hall, 1986) such phases are mentioned at page 227. Further detail may be found in “Food emulsions” of S. Friberg (Marcel Decker, 1976 at page 82).

Such mesomorphic phases may advantageously be formed by heating a mixture containing the edible surfactant and water to a temperature above the Krafft temperature, followed by cooling. It should be noted further that the above mentioned Lipid Handbook mentions at page 227 the use of mesomorphic phases of saturated, distilled monoglycerides as additives for processed potatoes or cake emulsions. However, this application is used for aerating bakery batters and enhanced complexing with amylose in non-finished starch based products. In the former application the aerating effect is ascribed to the better distribution of the monoglycerides in the batter system and in the latter application the monoglycerides form insoluble complexes with amylose, responsible for the crumb softening effect in bread and the texture improving effects on potato products and pasta foods. The emulsifiers are added to the bakery products before baking and to the potato products before final processing and consequently there is no mesomorphic phase in the finished products. The use of mesomorphic phases in such preparation methods for cake batters is not embraced within the scope of the present invention.

In a preferred embodiment of the invention the mesomorphic phase is a lamellar gel phase. These phases can include a sensational amount of water, e.g. up to 98 or even 99 wt. %, based on the mesomorphic phase of edible surfactant and water, although typically for bars lower levels of water will be desirable to hinder water migration between layers.

Another preferred element of the present invention is the presence of bulk regions of mesomorphic phases in the fillings of food bars. Most preferred is the presence of bulk regions of mesomorphic lamellar phases. Bulk phases preferably comprise either a more or less continuous mesomorphic phase or discrete particles of mesomorphic phase, for example having a number average particle size of between 1 μm and 1,000 μm. In this respect it should be noted that it has been suggested that known products of the prior art might contain non-bulk boundary layers of the lamellar phase at o/w interfaces, such as those found around oil droplets in water-continuous fatty products. The bulk regions of mesomorphic phase of edible surfactants may advantageously be used for replacing the aqueous phase and/or oil phase in food bars in accordance with the invention.

Preferably food bars in accordance with the invention contain filling layers having at least 5% by volume of mesomorphic phase of edible surfactant, more preferred 10-100% by volume, for example 20-80% by volume, whereby the volume of the mesomorphic phase refers to the volume of the combined water/edible surfactant system.

According to the present invention any edible surfactant may be used although lipidic substances are preferred. However, the use of other, non lipidic surfactants, for example surfactant or amphiphylic carbohydrates is not excluded. In general the preferred edible surfactants are selected from the group consisting of nonionic surfactants, anionic surfactants and cationic surfactants and mixtures thereof.

Preferred non-ionic surfactants are edible monoglycerides, diglycerides, poly-glycerol esters, non-ionic phospholipids, non-fatty carboxylic acid esters of fatty acid esters, partial sugar-fatty acid esters and, partial fatty acid esters of polyols and mixtures thereof.

Preferred cationic surfactants are cationic phospholipids, cationic non-fatty carboxylic acid esters of fatty acid esters and mixtures thereof.

Preferred anionic surfactants are lactylated fatty acid salts, anionic phospholipids, anionic non-fatty carboxylic acid esters of fatty acid esters and their metal salts, fatty acids and their metal salts and mixtures thereof.

The fatty acid chains used in these surfactants can be of any type and origin. Preferably, however C8-28 fatty acid chains are present, more preferred C12-22, for example C14-18. The fatty acids may for example be saturated, unsaturated, fractionated or hydrogenated and be derived from natural (for example dairy, vegetable or animal) source or synthetic sources.

Typical embodiments of the invention as illustrated hereafter by example comprise as the mesomorphic phase, in particular the bulk mesomorphic phase a combination of a major amount of a non-ionic surfactant and a minor amount of an ionic co-surfactant. Preferably, the mesomorphic phase comprises 1-30%, e.g., 2-10 wt. % of non-ionic surfactant for example monoglycerides and 0.005-10% more preferred 0.01-1 wt. % of ionic co-surfactant for example an alkali metal salt of a lactylated fatty acid, preferably sodium stearoyl lactylate, the percentages being based on the total weight of the mesomorphic phase.

The presence of “non-ionic,” “cationic” and “anionic” surfactants is of course dependent on the pH-value of the foodstuff in which the surfactants are used. In this respect it should be noted that normally the pH for foodstuffs is between 3-8, for dairy products the pH-value is in the range of 4-7.

The combination of non-ionic and ionic surfactants is preferred because the ionic surfactants are believed to give rise to an electrical charge at the interface of the mesomorphic structure used according to the present invention. The mutual repulsion at the interface of surfactant and water in the mesomorphic phase, for example the lipid bi-layers in a mesomorphic lamellar structure, creates a layer structure in which a surprisingly large amount of water can be incorporated. This phenomenon allows for the use as edible fat replacer and water retention agent as attractive applications.

Preferably the nonionic surfactant and the ionic surfactant are used in weight ratios of from 100:1 to 1:10, more preferred 50:1 to 1:1, for example 40:1 to 10:1.

Preferred non-ionic surfactants are monoglycerides, lactylated esters of monoglycerides and phospholipids. Preferred ionic co-surfactants are alkali-metal salts of lactylated fatty acids, e.g. sodium stearoyl lactylate (SSL), citric acid esters, ionic phospholipids (phosphatidic acid (PA), succinated esters and diacetyl tartaric acid ester of monoglyceride (DATEM).

Especially in the presence of the alkali metal salt of a lactylated fatty acid, a monoglyceride-based mesomorphic system can take up a large quantity of water into the inter-planar water layers, and this ‘swelling’ of the emulsion improves suitability of the products as edible fat replacers. While the invention will be illustrated hereafter by reference to examples in which the surfactant system comprises both monoglyceride and SSL, the use of other, single surfactants or preferably combinations of two or more surfactants to obtain a swellable mesomorphic system is not hereby excluded.

While fillings according to the invention generally will comprise less than 80% by weight of fat, the preferred level is 0-79 wt. % fat, for example 0 to 40%, preferably 1-30%. In some products at least low levels of fat may be required as a flavor carrier.

It has also been found that the mesomorphic phase, which is used according to the invention, can be used in foodstuffs containing electrolyte, without affecting the structuring capability of the system. One example of electrolytes that may be incorporated is sodium chloride. The amount of electrolytes such as salt in fillings according to the invention preferably ranges from about 0.01-5 wt. %, more preferred 0.1 to 3%, for example 0.2 to 2% based on the total weight of the filling.

The present invention relates to a finished foodstuff, namely a food bar, containing a mesomorphic phase of edible surfactant. For the purpose of the present invention, finished foodstuffs are food-products which are intended to be eaten without significant further processing. Excluded by this term are batters, doughs etc.

In one aspect the invention relates to a food bar comprising a crème or filling including a mesomorphic phase of edible surfactant, preferably less than 80% by weight of edible oil, and preferably less than 80 wt. % water, especially, 75 wt. % or less water. Preferably the crème or filling includes at least 1 wt. % water, especially at least 5 wt. % water. Water activity for the crème or filling is preferably within the range of 0.7 or less, down to 0.45.

While foodstuffs according to the present invention can comprise a mesomorphic phase comprising 99-5 wt. % of water, it is preferred that the mesomorphic phase comprises 85 wt. % of water or less, e.g., 60-85 wt %, the percentages being based on the total weight of the mesomorphic phase. Preferably the total level of edible surfactants in filling layers of the invention is from 0.1 to 30%, more preferred 1-15%, most preferred 2-10% by weight of the filling layer.

The mesomorphic phases of edible surfactants which are used according to the present invention, can be used in fillings containing a bio-polymer such as carbohydrates e.g. pectins, rice starch, other starches and carrageenan, or proteins. Suitable materials are for example milk protein, gelatin, soy protein, xanthan gum, locust bean gum, agar, hydrolysed starches (for example PaselliSA2 and N-oil) and microcrystalline cellulose.

The amount of biopolymer in compositions of the invention is dependant on the desired degree of gelling and the presence of other ingredients in the composition. Usually the amount of gelling agent lies between 0 and 30%, mostly between 0.1 and 25% based on the weight of the aqueous phase of the product. If hydrolyzed starches are present their level is preferably from 5-20%; other gelling agents are generally used at levels of up to 10%, mostly 1-7%, most preferred 2-5%, all percentages being based on the weight of the aqueous phase. Particularly preferred are combinations of, say, 5-15% hydrolyzed starch and 0.5-5% of other gelling materials. Preferably the other gelling material includes gelatin.

It is preferable that fat and mesophase containing fillings should comprise less than 10% saturated fat or equivalent thereof on product and/or less than 10% trans fat or equivalent thereof on product.

Other ingredients useful for the filling include humectants such as glycerine (e.g., 0 to 75 wt. % of filling, especially 1 to 50 wt. %), a sugar such as sucrose (e.g., 0 to 75 wt. % of filling, especially 1 to 50 wt. %), a sugar alcohol causing less GI disturbance such as erythritol, or another polyol (e.g., 0 to 75 wt. % of filling, especially 1 to 50 wt. %). Also useful for the filling are fibers (0 to 50 wt. % of filling, especially 1 to 30 wt. %), fat replacers such as Z-Trim (available from FiberGel Technologies, Inc. of Mundelein, Ill.) e.g., 0 to 25 wt. % of filling, especially 1 to 20 wt. %) and salt.

The filling will typically be used at from 10 to 50, especially 15 to 35 wt. % of the bar.

It can be expected that other layers of the bar will have lower water activities than the mesophase-containing filling. Consequently, in accordance with the invention, edible moisture barrier layers may be interposed between the mesophase containing layer and other layers. Edible coatings reported in U.S. Pat. Nos. 6,174,559 and 6,197,353 (gluten derived colloidal dispersion), U.S. Pat. No. 5,543,164 (protein based), U.S. Pat. No. 5,401,158 (saturated lipid plus protein isolate and emulsifiers), U.S. Pat. No. 5,128,159 (denatured proteinaceous coating), CA 2,044,428 (protein isolate, saturated lipid, and emulsifier containing diacetyl tartaric acid ester of monoglyceride), EP 451 491 (mixture of edible fat and milk protein), U.S. Pat. No. 5,182,130 (edible prolamine latex), WO 9009105 (collagen film), U.S. Pat. No. 3,653,925 (wheat gluten), U.S. Pat. No. 3,323,922 (edible fat), GB 2,363,049, U.S. Pat. No. 5,853,778 (film of edible material for sandwiches), WO 9842214 (lipid derived from dried fat and a hydrocolloid component), U.S. Pat. No. 5,248,512 (milk protein and optionally pregelatinized starch), U.S. Pat. Nos. 4,820,533, 4,661,359, EP 550 445, 4,915,971, 4,401,681, 3,997,674, 2,909,435 may be found to be useful.

For preparing fillings containing the mesomorphic phase in accordance with the invention, it is possible to prepare the mesomorphic phase separately and add this phase as an ingredient to the other ingredients of the product, or it is possible to prepare the mesomorphic phase “in-situ” in the presence of one or more other ingredients of the composition. In any case, however, the preparation of the mesomorphic phase preferably takes place while heating to a temperature above the Krafft temperature, followed by cooling. Generally these temperatures are from 0-100° C., more generally 30-90 C., most generally 40-70° C. Any heat-sensitive ingredients or ingredients which could prevent the formation of a mesomorphic phase are preferably added after cooling.

It is suggested that water activity of the bar and its components stay within a selected range of less than 0.7, especially from 0.5 to less than 0.7 more preferably from 0.63-0.68. Water activity may be determined using one of the water activity meters sold under the name of Aqualab by Decagon Devices of Pullman, Wash. Yeast and mole inhibitors such as potassium sorbate and sodium benzoate may be added to the mesomophoric phase.

The food bars of the invention, especially the base layer(s), may include protein sources. Preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in other forms, or both in nuggets and external to nuggets.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the food bars of the invention, particularly when the food takes the form of a nutrition bar, are preferably within the range of 3 wt. % to 50 wt. %, such as from 3 wt. % to 45 wt. %, especially from 3 wt. % to 20% for lower protein level products and from 20 to 30 or 35 wt. % for higher level protein products.

When protein nuggets are employed, they typically include greater than 50 wt. % of protein selected from the group consisting of milk protein, rice protein and pea protein and mixtures thereof, especially between 51 wt. % and 99 wt. %, more preferably between 52 wt. % and 95 wt. %, most preferably 55 wt. % or above. Other ingredients which may be present in the nuggets would include one or more of other proteins, such as those listed above, include lipids, especially triglyceride fats, and carbohydrates, especially starches. Particularly where the nuggets are made using the moderated temperature extrusion process described below, it is advisable that the remaining ingredients be no more sensitive to heat degradation (e.g., have the same or lower degradation point) than the selected non-soy protein.

The food bars of the invention may include sources of unsaturated fatty acids. Among these may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

If desired, the food bars of the invention may include sources of omega-3 and/or omega-6 fatty acids, some of which are mentioned above. Among those which may be useful are included arachidonic acid, docosahexaenoic acid (DHA), eicosapentaenoic acid (EPA), lineoleic acid, linolenic acid (alpha linolenic acid) and gamma-linolenic acid.

The food bar of the invention may include various other oils or fats. In addition to those mentioned above, such oils and fats include other vegetable fat, such as for example, cocoa butter, illipe, shea, palm, palm kernal, sal, soybean, safflower, cottonseed, coconut, rapeseed, canola, corn and sunflower oils, or mixtures thereof. A blend of oils (e.g., canola, soybean, or high oleic oils) may be used, especially containing either synthetic antioxidants such as BHT, TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product.

In general, oils containing PUFA moieties may be encapsulated, if desired. Where these are used, added antioxidants such as tocopherols, ascorbic acid and/or rosemary extract may be omitted; that is, the oils may be free of added antioxidants. Where non-encapsulated oils containing PUFA moieties are used, it is preferred that added antioxidants such as tocopherols, ascorbic acid and/or rosemary extract be present in the oil.

In the case of a nutrition or other food bar, preferably the amount of fat is not more than 45 wt. %, especially not more than 35 wt. %, preferably from 0.5 to 10 wt. %, still preferably from 0.5 to 5 wt. %.

Preferably the food bar of the invention has a water activity of 0.75 or less, preferably 0.65 or less, especially 0.6 or less.

Carbohydrates can be used in the food bar of the invention at levels of from 0 to 90%, especially from 1% to 49%. In addition to sweeteners, the fibers and the carbohydrate bulking agents mentioned below, examples of suitable carbohydrates include starches such as are contained in rice flour, flour, peanut flour, tapioca flour, tapioca starch, and whole wheat flour and mixtures thereof. The levels of carbohydrates in the nutrition bar or other bar of the invention as a whole will typically comprise from 5 wt. % to 90 wt. %, especially from 20% to 65 wt. %.

If it is desired to include a bulking agent in the food, in addition to the mesomorphic phase, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches. Total bulking agent levels in the food bars of the invention, will preferably be from about 0% to 20 wt. %, preferably 5% to 16%. Preferably, the amount of sugar alcohol in one or all of the filling layer(s) is minimized or even nil.

Flavorings are preferably added to the food or nutrition bar in amounts that will impart a mild, pleasant flavor. The flavoring may be in nuggets or external to the nuggets in the bar, provided that processing is not adversely affected. The flavoring may be any of the commercial flavors employed in nutrition bars or other food bars, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste. Suitable flavorants may also include seasoning, such as salt (sodium chloride) or potassium chloride, and imitation fruit or chocolate flavors either singly or in any suitable combination. Flavorings which mask off-tastes from vitamins and/or minerals and other ingredients are preferably included in the products of the invention. Preferably, flavorants are present at from 0.25 to 3 wt. % of the food, excluding salt or potassium chloride, which is generally present at from 0 to 1%, especially 0.1 to 0.5%.

Any nuggets and the bar may include colorants, if desired, such as caramel colorant. Colorants are generally in the food at from 0 to 2 wt. %, especially from 0.1 to 1%.

If desired, the food bars, especially the nuggets, may include processing aids such as calcium chloride.

In addition to the edible surfactants used to produce the mesomorphic phase, the food bars may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides are preferred. The emulsifiers used for purposes other than mesophase formation may be present in the bar and/or protein nuggets, at levels overall of about 0.03% to 0.3%, preferably 0.05% to 0.1%. Typically all of these will be present in the base layer(s) and/or coating. Emulsifiers may be used in combination, as appropriate.

Among fiber sources which may be included in the foods of the invention are fructose oligosaccharides (fos) such as inulin, guar gum, gum arabic, gum acacia, oat fiber, cellulose, whole grains, and mixtures thereof. The compositions preferably contain at least 2 grams of fiber per 56 g serving, especially at least 5 grams of fiber per serving. Preferably, fiber sources are present in the product at greater than 0.5 wt. % and do not exceed 6 wt. %, especially 5 wt. %. As indicated above, additional bulking agents such as maltodextrin, sugar alcohols, corn syrup solids, sugars, starches and mixtures thereof may also be used. Total bulking agent levels in the products of the invention, including fibers and other bulking agents, but excluding sweeteners will preferably be from about 0% to 20%, especially from 1 to 15 wt. %. The fiber and the bulking agent may be present in the food as a whole, e.g., the food bar, and/or in nuggets, etc. provided that processing is not impaired.

Carrageenan may be included in the food bars of the invention, internal or external to any nuggets, e.g., as a thickening and/or stabilizing agent (0 to 2 wt. % on product, especially 0.2 to 1%). Cellulose gel and pectin are other thickeners which may be used alone or in combination, e.g., at 0 to 10 wt. %, especially from 0.5 to 2 wt. %.

Typically, the food bar will be naturally sweetened, at least in part. The sweetener may be included in any nuggets or elsewhere in the bar provided that it does not interfere with processing. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Levels of sweeteners and sugar sources preferably result in sugar and/or other polyol solids levels of up to 20 wt. %, especially from 10 to 17 wt. % of a food bar. In accordance with the invention, it will generally be desirable to eliminate or minimize sugar alcohols from one, more than one, and/or all of the filling layer(s).

If it is desired to use artificial sweeteners, these may likewise be present in the nugget and/or within the bar, provided that they do not interfere with processing. Any of the artificial sweeteners well known in the art may be used, such as aspartame, saccharine, Alitame® (obtainable from Pfizer), acesulfame K (obtainable from Nutrinova), cyclamates, neotame, sucralose, mixtures thereof and the like. The artificial sweeteners are used in varying amounts of about 0.005% to 1wt. % on the bar, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%.

Calcium may be present in the nutrition bars at from 0 to 100% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate), copper (e.g., as copper sulfate), and Zinc (as Zinc Oxide). The vitamins-and minerals are preferably present at from 5 to 100% RDA, especially 5 to 50% RDA, most especially from about 15% RDA. The vitamins and/or minerals may be included within, or external to, the nuggets, provided that processing and human absorption are not impaired.

RDA as referred to herein is the Recommended Dietary allowances 10^{th} ed., 1989, published by the National Academy of Science, National Academy Press, Washington, D.C.

Ingredients which, if present, will generally be found within a bar but external to any nuggets include, but are not limited to, rolled oats, chocolate or compound chips or other chocolate or compound pieces, cookie and/or cookie dough pieces, such as oatmeal cookie pieces, brownie pieces, fruit pieces, such as dried cranberry, apple, etc., fruit jelly, vegetable pieces such as rice, honey and acidulants such as malic and citric acids, leavening agents such as sodium bicarbonate and peanut butter.

The food bars of the invention may be made by known methods. Ingredients are added to the foods at a convenient time in the processing, provided that any temperature sensitive ingredients are not exposed to temperatures which cause degradation of their components. Likewise, if protein-containing nuggets are present, the processor must be sensitive to any conditions which could cause degradation of the nugget.

The bars may be single extruded, coextruded, or made by sheeting through a roller (Sollich). The filling layer may be coextruded with a base or other layers. Or, the filling layer may be extruded or coated onto a pre-formed base layer.

Extruded nutritional or other food bars, or their component layers, may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. Any nuggets should only be added to the syrup when the syrup is at a temperature below that at which any of the nugget components degrade. Syrup ingredients may include components such as corn syrup, glycerine (0-20 wt. % on total product, especially 0.5 to 10 wt. %), lecithin and soybean oil or other liquid oils. In addition to the nuggets, other dry components include grains, flours (e.g., rice or peanut), maltodextrin, protein isolates and milk powders.

Food and/or nutritional bars in the form of granola bars may be made by cooking the syrup, adding the dry ingredients, blending the syrup and dry ingredients in a blender, feeding the blended mix through rollers and cutting with a cutter. The mesomorphic phase-containing layer can be layered upon the granola layer. If desired, a second granola layer can be placed atop the filling layer to form a sandwich.

The bars of the invention may be coated, e.g. with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, the uncoated bars of the invention will be made from 30-50 wt. % syrup, especially 35-45%, and 50-70 wt. % dry ingredients, especially 55-65 wt. %. Generally, coated bars according to the invention will be made from 30-50 wt. % syrup, especially 35-45 wt. %, 40-50 wt. % dry ingredients, especially 40-45% and 0-30 wt. % coating (e.g., chocolate or compound coating), especially 5-25 wt. %, particularly 10-20 wt. % coating.

Nuggets may contain greater than 50 wt. %, especially greater than 60%, more preferably greater than 70 or 80% of selected proteins such as non-soy proteins selected from the group of milk protein, rice protein and pea protein.

It can be expected that the benefits of the invention will be realized in various types of food bars, including various types of nutrition bars having vitamins and minerals including, without limitation, snack bars and meal replacement bars. Examples include layered bars wherein the filling comprising mesophase surfactant is disposed adjacent at least to one base layer. Other examples include extruded bars wherein the filling layer comprises mesophase surfactant. Such bars can advantageously be subjected to high temperature short time purification treatments.

More specifically, bars according to the invention may be made by combining syrups with salt in a steam jacketed kettle, cooking to 110-240° F., transferring to single or double arm mixer, and then adding at room temperature:
Proteins, and mixing,
Adding flavors and oils, and mixing,
Adding vitamin premix, inulin or other (optional) fiber and cocoa,
Adding cookie pieces, if desired, and
Cooling the product to 70-92° F.

The product is then transferred to a bar extruder, such as the bar press machine available from APV Bar Press, Grand Rapids Mich. The bar's core material is extruded into predetermined shape, the typical dimensions of which are 1.5 inch wide and by ⅝ inch thick. The Single length extruded rope is then cut to size using a guillotine cutter.

The mesomorphic phase layer is layered along the length of the bar. The length is then enrobed in chocolate or chocolate compound coating at 98-105° F. and cooled to set the coating (40-60° F.) in a cooling tunnel. The bar is then packaged.

### EXAMPLES

The following ingredients are used:

The surfactants named Hymono and Admul followed by a code all are trade names of Quest International. HY designates Hymono. The various types of Beta-carotene are obtained from Hoffmann-La Roche Ltd, Basel, Switzerland. BMP is butter milk powder. SMP is skimmed milk powder. Salt is sodium chloride. DATEM is Admul Datem 1935.

### Example A (Prophetic)

Separate Preparation of Mesomorphic Phase

A mesomorphic phase of edible surfactant is made of the following ingredients:

| | |
|---|---|
| Distilled water | 74.4% |
| Monoglycerides (*) | 12.0% |
| Lactylated fatty acid (**) | 0.6% |
| Glycerine | 13% |

Notes:
(*) Hymono 1103 (ex Quest Int.)
(**) Admul SSL 2004 (ex Quest Int)

The water is heated in a water-jacketed vessel until a temperature of 65° C. At that point all other ingredients are added to the water and the mixture is stirred gently, using a ‘ribbon stirrer’, for about 30 minutes. The pH of the product is set to a value of 4.6 using lactic acid. The product is cooled to ambient temperature.

The resulting product is a mesomorphic phase. The product could be used in the preparation of a food bar in accordance with the invention.

### Example B (Prophetic)

Separate Preparation of Mesomorphic Phase

A mesomorphic phase is prepared with the following composition:

| | |
|---|---|
| Monoglyceride (*) | 12% |
| Sodium Stearoyl Lactylate (**) | 4% on mono. |
| Glycerine | 12.5% |
| Water | to 100% |
| Color/Flavor | trace |

Notes
(*) = Hymono 1103
(**) = Admul SSL 2004

All ingredients are hand blended at 65° C. and the blend is neutralized with sodium hydroxide solution to pH 7.0. The resulting mixture is cooled to 10° C. The resulting product is believed to be a mesomorphic phase.

### Example C (Prophetic)

Separate Preparation of Mesomorphic Phase

A mesomorphic phase is prepared with the following composition:

| | |
|---|---|
| Tap water | 76.5% |
| Monoglycerides | |
| Saturated(Hymono 8903) | 6% |
| Unsaturated (Hymono 7804) | 4.5% |
| Co-surfactant (Admul DATEM 1935) | 1% |
| Glycerine | 12% |

The water is heated until 55° C. on an electric heating plate equipped with a magnetic stirring facility. At 55° C. the surfactants are added to the water and mixed using the magnetic stirrer, until distributed homogeneously (about 75 minutes). Then the mesomorphic phase is slowly cooled down to room temperature under continuous stirring.

In this way a plastic gel phase is obtained which does not show phase separation upon storage or spreading. The gel phase gives a distinct fatty oral impression.

### Example D (Prophetic)

Separate Preparation of Mesomorphic Phase

A bulk mesomorphic phase is prepared with the following composition:

| | |
|---|---|
| Hymono 1103 | 6% |
| SSL (Admul SSL 2004) | 5% on mono |
| Glycerine | 11% |
| Water | balance |
| Colour/flavour | trace |

All ingredients are mixed together in a stirred water jacketed vessel at 65° C., and neutralized with sodium hydroxide to pH 7.0.

Examples 1-4 (Prophetic) illustrate preferred, lower moisture, mesophase filling formulations.

### Example 1

| Ingredient description | % |
|---|---|
| Water | 73 |
| HY mono | 17.3 |
| Datem | 1 |
| Xanthan Gum | 0.5 |
| Ultrasperse/Z-trim | 8 |
| K-sorbate | 0.2 |
| Total | 100 |

### Example 2

| Ingredient description | % |
|---|---|
| Water | 36.5 |
| HY mono | 8.7 |
| Datem | 0.5 |
| Xanthan Gum | 0.2 |
| Ultrasperse/Z-trim | 4 |
| K-sorbate | 0.05 |
| Sodium benzoate | 0.05 |
| Glycerine | 50 |
| Total | 100 |

### Example 3

| Ingredient description | % |
|---|---|
| Water | 33 |
| HY mono | 7.8 |
| Datem | 0.4 |
| Xanthan Gum | 0.2 |
| Ultrasperse/Z-trim | 3.5 |
| K-sorbate | 0.05 |
| Sodium benzoate | 0.05 |
| Glycerine | 45 |
| Fiber (z-trim/Carrot fiber) | 10 |
| Total | 100 |

### Example 4

| Ingredient description | % |
|---|---|
| Water | 30 |
| HY mono | 7 |
| Datem | 0.4 |
| Xanthan Gum | 0.2 |
| Ultrasperse/Z-trim | 3.3 |
| K-sorbate | 0.05 |
| Sodium benzoate | 0.05 |
| Glycerine | 40 |
| Fiber (z-trim/Carrot fiber) | 9 |
| Betaine | 10 |
| Total | 100 |

### Example 5 (Prophetic)

A layered nutrition bar is prepared according to the following formulation. The mesophase filling is layered a top the bar base, after which the chocolate coating is applied.

| Ingredient description | % |
|---|---|
| Mesophase filling of Example 3 | 21 |
| Maltitol syrup | 15.5 |
| Choc. Coating | 18 |
| Acid casein | 8 |
| Hydrolyzed beef gelatin | 7 |
| WPI (whey protein isolate) | 3 |
| Hydrolyzed Whey protein | 3 |
| Whey protein | 4 |
| Di cal. Phosphate | 1 |
| Encap di pot. Phosphate | 2 |
| Vitamin/mineral pre-mix | 1 |
| Peanut | 5 |
| Peanut large | 1.5 |
| Oligofructosaccharides | 1 |
| Nat. peanut flavor | 0.5 |
| Roasted peanut flavor | 0.3 |
| Peanut butter | 1.5 |
| Water | 2 |
| Salt | 0.1 |
| Nat. peanut extract | 0.2 |
| Non-nutritive sweetener | 0.05 |
| Nat. masking flavor | 0.006 |
| Glycerine | 5 |

It will be appreciated that when fatty acids are mentioned herein, generally these will be present in the form of glycerides such as mono-, di- and triglycerides. Therefore, “fatty acids” encompasses glycerides containing them.

Unless stated otherwise or required by context, the terms “fat” and “oil” are used interchangably herein. Unless otherwise stated or required by context, percentages are by weight.

The word “comprising” is used herein as “including, but not limited to” the specified ingredients. The words “including” and “having” are used synonymously.

It should be understood of course that the specific forms of the invention herein illustrated and described are intended to be representative only, as certain changes may be made therein without departing from the clear teachings of the disclosure. Accordingly, reference should be made to the appended claims in determining the full scope.

What is claimed is:

1. A food bar comprising bulk regions of a mesomorphic phase of edible surfactant.

2. The food bar according to claim 1 wherein said mesomorphic phase comprises from 5-35 Wt % edible surfactant and from 20-80% water.

3. The food bar according to claim 1 wherein said mesomorphic phase is included within a filling layer which is disposed adjacent a base layer.

4. The food bar according to claim 1 wherein the mesomorphic phase is contained within a layer having a water activity of from 0.45 to 0.7.

5. The food bar according to claim 1 wherein the mesomorphic phase is contained within a layer which further includes a humectant.

6. The food bar according to claim 5 wherein the humectant is selected from the group of glycerine, sugars, fibers and salts and mixtures thereof.

7. A layered food bar comprising at least one base layer and at least one filling layer disposed adjacent thereto, said filling layer comprising mesomorphic phase of edible surfactant.

8. The food bar according to claim 7 further comprising a coating adjacent at least one of said base and filling layers.

9. The food bar according to claim 7 wherein the water activity of the filling layer is within the range of from 0.45 to 0.7.

10. The food bar according to claim 7 wherein said mesomorphic phase comprises from 5-35 Wt % edible surfactant and from 20-80% water.

11. The food bar according to claim 7 further comprising at least one edible film which is a barrier to moisture migration interposed between the filling layer and the base layer.
